(19) United States
(12) Patent Application Publication
(10) Pub. No.: US 2005/0188299 A1
(43) Pub. Date: Aug. 25, 2005

(54) System and method for generating construction document submittal packages

(76) Inventors: George Furman, Lebanon, IN (US); Julie Hochstatter, Fishers, IN (US); George Jones, Fishers, IN (US); Craig Oxendine, Fishers, IN (US)

Correspondence Address: John M. Vasuta;Bridgestone Americas Holding, Inc., 1200 Firestone Parkway, Akron, OH, 44317, US

(21) Appl. No.: 11/058,790

(22) Filed: Feb. 16, 2005

Related U.S. Application Data
(60) Provisional application No. 60/546,512, filed on Feb. 20, 2004.

(51) Int. Cl. G06F 17/00

(52) U.S. Cl. 715/513; 707/1

(57) ABSTRACT

A system and method of generating a submittal package is provided. The method includes entering relational data using an Expert Logic Engine, selecting pre-established documents from the relational data, preparing reports from the relational data, and combining the reports and documents to form a submittal package. The system includes means for entering relational data using an Expert Logic Engine, means for selecting pre-established documents from the relational data, means for preparing reports from the relational data, and means for combining the reports and documents to form a submittal package.

### CROSS REFERENCE TO RELATED APPLICATIONS

The application claims the benefit of U.S. Provisional Application No. 60/546,512 filed Feb. 20, 2004.

### BACKGROUND OF THE INVENTION

This invention relates to the construction industry and more particularly to a system and method for generating submittal packages.

Construction projects can be complicated and require a large amount of interrelated information in order to facilitate completion. Even single purpose projects, such as installing a roof, can include installing a variety of different products all having Material Safety Data Sheets, Technical Information Sheets, drawings, and the like.

Building systems are becoming more and more sophisticated in order to more effectively address the variety of problems presented by construction projects. These systems are providing a wider range of solutions to the builder resulting in a growing number of available products. More products means more product information. Often times many of the products interrelate with each other in specific ways which can further complicate the production and utilization of this mass of data.

The construction manager or the contractor must keep track this large amount of data for the project in order to provide the proper information to interested parties. The contractor usually provides this information in the form of submittals. Submittals can include a number of documents, each providing information pertinent to particular aspects of the construction project.

For example, the contractor often must provide documents describing the project in terms of the materials, the installation methods and the costs in a bid submittal when bidding on a construction project. In another example, after a contractor gets a construction job, the contractor must often submit a construction submittal proving that the statements/promises that were made in the bidding process will be kept during construction. Sometimes submittals must be provided to architects, or to zoning committees, or other parties with an interest in the project.

Environmental agencies can also require that material safety data, including data on any potentially hazardous products, be provided in a coherent and organized manner. The technical information related to many products can be important for proper installation and for warranty requirements.

Manufacturers often require the contractor to provide information on construction projects which use the manufacturer's products. The manufacturers often issue warranties on their products. They typically require the contractor to supply product and installation information prior to commencing the construction project. In the past, the contractor had to fill out forms and manually assemble this information and provide it to the manufacturer requiring considerable time and effort.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a system for generating submittal packages in accordance with the invention;

FIG. 2 is a flow chart illustrating steps of the invention;

FIG. 3 is a flow chart illustrating steps of the invention; and

FIG. 4 is a flow chart illustrating steps of the invention.

### DETAILED DESCRIPTION OF THE PREFERRED EMBODIMENTS

The scope of the applicability of the present invention will become apparent from the detailed description provided herein. It should be understood, however, that the detailed description and specific examples, while indicating preferred embodiments of the invention, are given by way of illustration only, since various changes and modifications within the spirit and scope of the invention will become apparent to those skilled in the art.

For the purposes of the invention described herein, a construction submittal package can be a collection of information used for a construction project. The examples provided below pertain to roofing construction projects, though these examples should not be construed as unnecessarily limiting the invention to the roofing industry

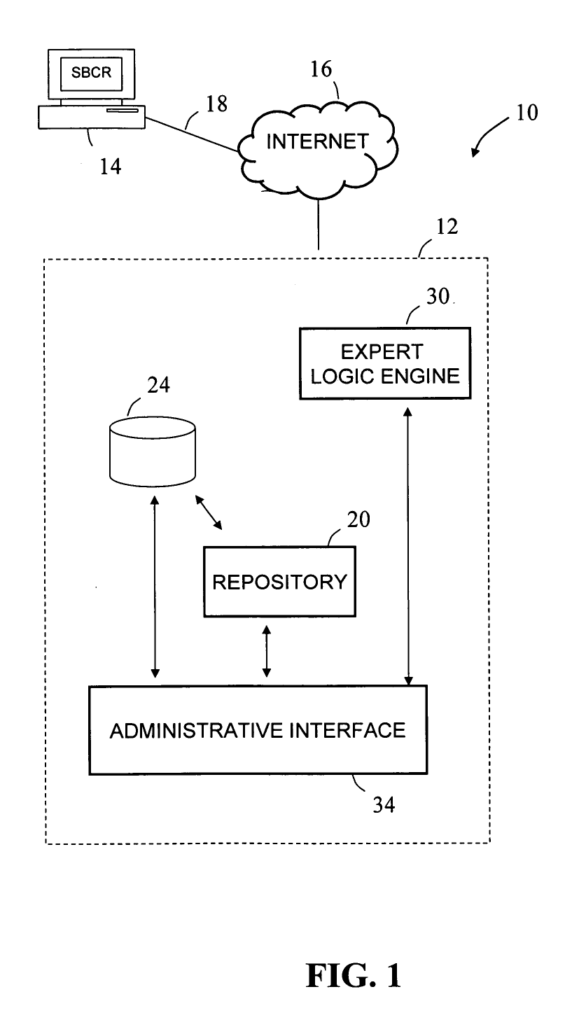

Referring to FIG. 1 a block diagram of at least a portion of a system for generating submittal packages is shown generally at 10. The system 10 includes an application server 12 for running software capable of accomplishing the tasks described herein, also referred to as the application. The application server 12 can be connected to a user device 14 across a network 16, such as the Internet or intranet, by a network connection 18. The user device 14 can be a computer, a cellular phone or any other electronic device for communicating with the application server 12 in a manner described herein. The user device 14 allows the user, also referred to as a subscriber, to enter information into the application 12 for generating the submittal packages, including data for pre-selecting documents as described below. The user device 14 can also allow the user to view submittals and receive submittal packages downloaded from the server 12 such as via email. For simplicity, only one user device 14 is shown and the system is described with a single user preparing a submittal package, however, it should be appreciated that a plurality of users can simultaneously communicate with the application server 12 about separate accounts using different user devices connected to the application server. As a result, the system 10 is capable of servicing a plurality of different users 14 simultaneously and preparing and/or manipulating a plurality of documents and submittal packages at one time.

The system 10 also includes a repository 20 for storing documents which can be included in the submittal package. The documents can be pre-established documents selected for inclusion in the completed submittal package based on their content. Pre-established documents are typically almost or fully completed when selected, accepting little or no additional information for inclusion therein. Examples of these pre-established documents can include, but are not limited to Material Safety Data Sheets, and Technical Information Sheets, among others.

The system 10 also includes a database 24 for storing submittal packages in electronic form. The submittal packages can be referenced in the database 24 for retrieval and/or manipulation by a job identifier and/or by construction site information and/or by user identifiers and/or account information or in other suitable manners. The system database 24 can enable the storage and concurrent manipulation of a large number of submittal packages by a large number of users. To save on storage requirements, the database 24 can store reference indicators, such as document number or title, which point to pre-established documents in the repository 20 rather than storing the pre-established documents themselves. The database 24 can store these document reference indicators in tables and group them with the corresponding submittal packages which they were selected for.

The system 10 also includes an Expert Logic Engine 30 for guiding the user through the data entry process using business/product rules. The Expert Logic Engine 30 business/product rules simplifies data entry, including the entry of relational data, as described in further detail below. The Expert Logic Engine business/product rules can be encrypted at the server 12 and sent to the user device 14 via the network connection 18 resulting in a distributed computing application which can provide the user with faster response times when using the system 10.

The system 10 also includes an Administrative Interface 34 communicating with the repository 20, database 24 and Expert Logic Engine 30. The Administrative Interface 34 provides an interface for performing administrative functions, examples of which can include but are not limited to, building, editing and maintaining the repository 20 and adding and/or editing the business/product rules in the Expert Logic Engine 30.

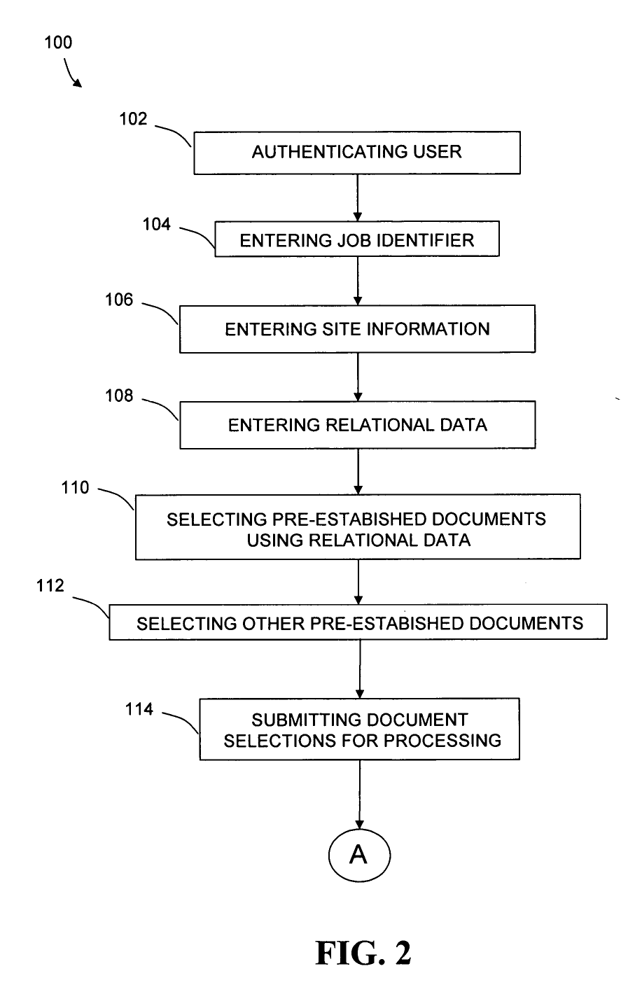

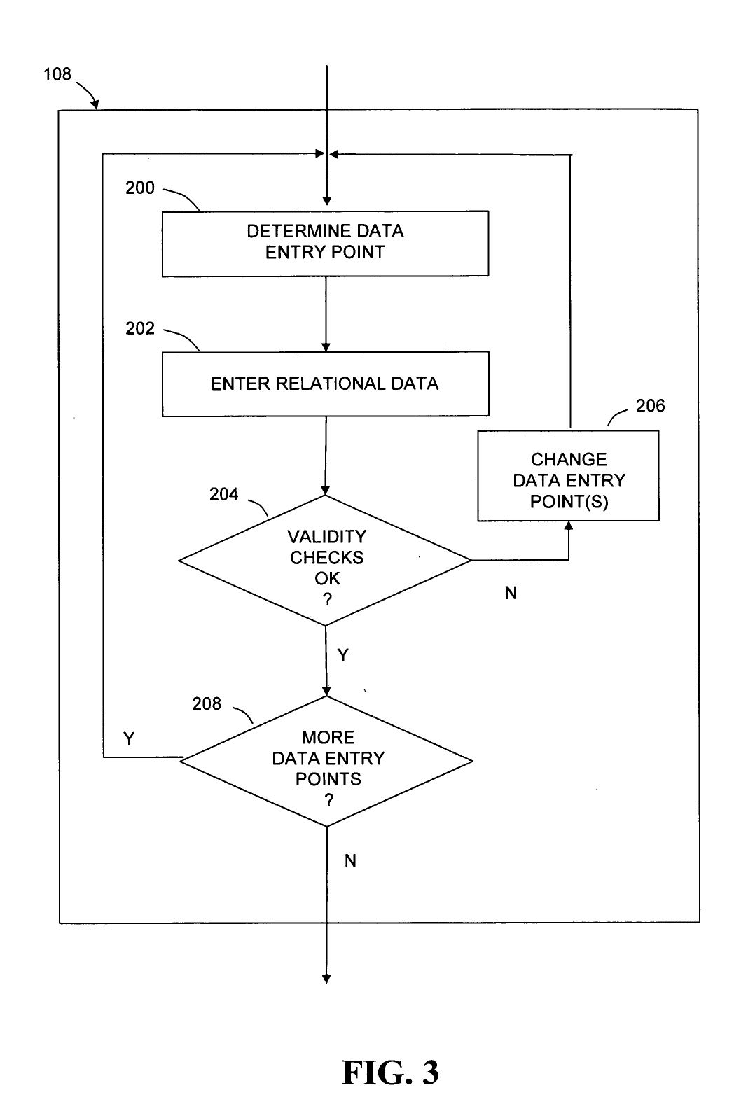

Referring now to FIGS. 2 and 3 a method of generating submittal packages is shown generally at 100. The user can gain access to the system 10 by logging on to a website, such as the manufacturer's website. The method can include authenticating the user at 102. User IDs and passwords can be used for security purposes to authenticate the user and allow them to access to the system 10. Multiple accounts can be available for customers having several employees who use the system. The user can also enter a job identifier, such as a job number and/or account number at 104 for use in identifying each submittal package generated for the user by the system 10, and for grouping together the corresponding pre-established documents and the reports used therein. This information is stored in the database 24.

The method 100 can also include the user providing site information at 106 identifying the building, the building owner, building address, etc. The site information can be used for generating reports, including the sample warranty, as described below.

The method 100 can also include the user entering relational data at 108. Relational data can be installation information and/or product information pertaining to the construction project. The Expert Logic Engine 30 can guide the user by providing a series of data entry points with each point requesting the entry of another piece of data by the user. The Expert Logic Engine 30 uses the business/product rules to determine the next data entry point for the user depending on the on relational data that the user entered previously.

Referring to FIG. 3, the step of entering the relational data at 108 is shown in detail. The Expert Logic Engine 30 determines the data entry point at 200 requesting the entry of data by the user. The data entry point can prompt the user for data and it can provide selection options. The user enters the relational data at 202 in response to the data entry point prompt(s). The Expert Logic Engine 30 performs validity checks on the entered data at 204 using the business/product rules. The validity checks 204 can be performed on some or all of the relational data entered up to this point if desired. If the validity checks are not satisfied, the Expert Logic Engine 30 can change one or more of the data entry points at 206 so that all the relational data entered up to this point satisfies the business/product rules. For example, new data entry points can be added and/or existing data entry points can be filtered out and removed.

If the validity checks are satisfied at 204, the Expert Logic Engine 30 determines if more data entry points exist at 208 and if yes, determines the next data entry point at 200. This process is continued until it is determined that no more data entry points exist at 208. In this manner, the Expert Logic Engine 30 using the business/product rules provides a quick and streamlined, data-specific guide to the user which simplifies data entry by tailoring the data entry points to the data provided and eliminating unnecessary and unused data entry points.

For the purposes of example, in a roofing construction project such as the installation of roofing material, the relational data can include installation data, product data, system information, construction information, number of decks, insulation information, and membrane information among others. This information is relational in that it is interdependent, with some pieces of the information depending on previously entered information. For example, if a MAS EPDM roof system is entered by the user as the type of roof to be installed, the Expert Logic Engine 30 uses the business/product rules which relate to MAS EPDM roof systems. These rules generate data entry points at 200 which prompt the user to enter relational data which depends from the MAS EPDM roof system. In response to the user entering MAS EPDM roof system, the Expert Logic Engine 30 generates a data entry point requesting the deck type. If the user enters a steel deck type at the data entry point, the Expert Logic Engine 30 generates another data entry point requesting the user to enter the gauge of the steel deck.

As another example, if the roof system to be installed is an APP Asphalt roof system, applicable information for that system is entered by the user for that type of roof. The Expert Logic Engine 30 uses the business/product rules which relate to APP Asphalt roof systems. These rules generate data entry points at 200 which prompt the user to enter relational data which depends from the APP Asphalt roof system. In response to the user entering APP Asphalt roof system, the Expert Logic Engine 30 generates a data entry point requesting the type of asphaltic base sheet to be used. If the user enters a Firestone MB Base Sheet, the Expert Logic Engine 30 generates a data entry point requesting the user to enter the application technique for that base sheet.

The relational data entry is continued according to step 108 for the example provided, to include data entry points for layers of insulation, insulation thickness, manner of attachment, etc. For example, if Firestone Fasteners are selected/entered by the user, the Expert Logic Engine 30 using the business/product rules generates length/type data entry point and a rate data entry point.

The method 100 can also include selecting pre-established documents from the repository using the information entered in steps 104, 106 and 108 at step 110. The data is used for selecting the pre-established documents but is not integrated into these documents. These pre-established documents can include Material Safety Data Sheets (MSDS) selected based on the product information entered above. These MSDS sheets provide safety information, such as any hazardous materials which may be included in the products. The pre-established documents can also include Technical Information Sheets and Details, such as drawings, providing installation instructions, visual details, etc. on the products entered above.

The selection step 110 may be incomplete and therefore may not select all the pre-established documents the user requires for the completed submittal package. Therefore, the method 100 can also include selecting other pre-established documents at 112. This selecting step 112 can be performed by providing the user with a repository view showing the pre-selected documents selected in step 110 as a check for the user to verify that the all of the documents for the submittal package have been selected.

For example, the repository view can be provided as a tree showing all of the documents in the repository 20 with the pre-selected documents checked or otherwise indicated as being pre-selected. The tree can identify documents using titles or short descriptors for simplifying this visual representation. A tree format can also provide organizational relationships between the pre-established documents in the repository which can help the user navigate the pre-established documents when checking for completeness or searching for documents that have not been pre-selected but are necessary for the submittal package. The user can, therefore, easily select other pre-established documents in step 112 by simply finding them in the tree structure and clicking on them with a mouse. These selected pre-established documents will then also have a check or other indicator indicating that they have been selected for inclusion in the submittal package. The user can then submit the documents selected in steps 110 and 112 for processing by simply clicking on a submit button at 114.

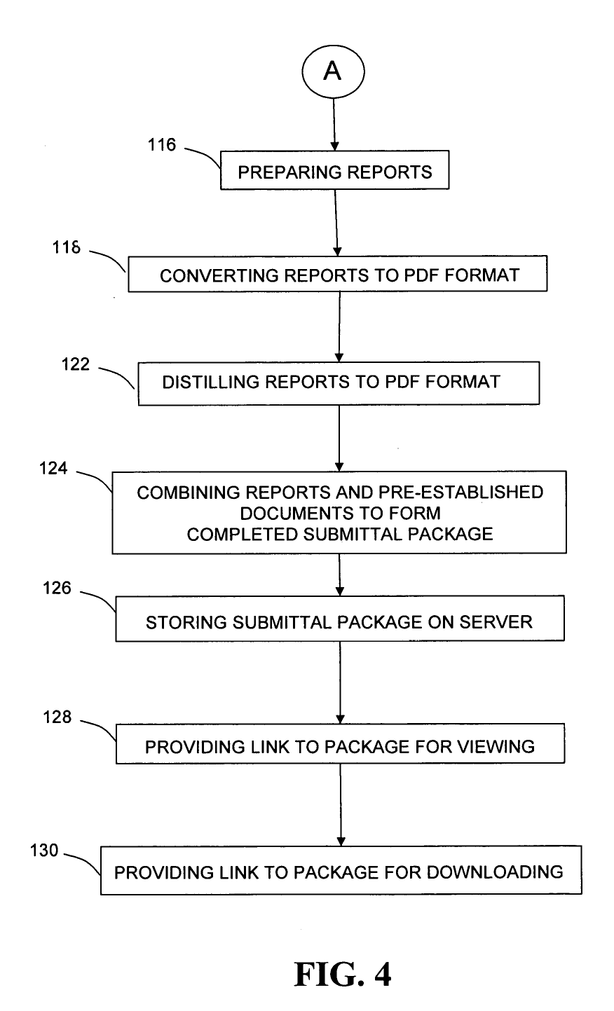

Referring now to FIG. 4, the method 100 can also include preparing reports at 116 from the data entered in steps 104, 106, and 108 in FIG. 2. These reports are not pre-established, but rather they integrate the data provided above.

The information entered in steps 104, 106 and 108 can be used to generate a notice report, such as a Pre-Installation Notice. The Pre-Installation Notice is typically submitted by the contractor to the Manufacturer of the building products prior to starting the construction project. For example, a contractor installing a roofing system using roofing products from Firestone Building Products will submit the Pre-Installation Notice to Firestone Building Products a couple weeks before installing the roofing system. The Pre-Installation Notice can be used to notify the manufacturer of the installation, and can provide the manufacturer information about the project.

The reports can also include a submittal package cover sheet providing general information about the submittal package. Examples of this information can include, but are not limited to, the manufacturer, job number, site name and address, the submitting company which can be the user or the user's employer and the submittal date. Other reports which can be prepared in the preparing step 116 can include the table of contents with page numbering.

The report can also be a Request for Inspection. The Request for Inspection is used for requesting that the construction project be inspected after completion in order to have the manufacturer issue the warranty. The Request for Inspection can include contractor identification information, building name and address or other information identifying the installation, the foreman's name and completion date, among other information.

The system 10 can be used to generate a Letter of Good Standing report. The Letter of Good Standing can be generated automatically by the application using the data entered in steps 104, 106, and 108. The Letter of Good Standing is a letter written by the manufacturer, such as the manufacturer of the building products being installed by the contractor, indicating that the contractor is licensed by the manufacturer for the product for warranty purposes. The Letter of Good Standing provides assurance that a valid warranty for the construction project can be issued and honored by the manufacturer. The Letter of Good Standing can also indicate the that contractor is authorized to install the manufacturer's product. The letter of Good Standing can also provide contact information for the manufacturer. If circumstances warrant it, the completed letter of Good Standing can be provided to the user as a stand alone report, such as in a PDF document, which can be transmitted apart from the complete submittal package.

The system 10 can be used to generate a Sample Warranty report. The site information and contractor information provided in steps 102 through 108 above can automatically be integrated into a Sample Warranty to produce an unsigned sample of what will be issued by the manufacturer upon completion of the construction project. The Sample Warranty can include the terms, conditions and limitations of the warranty for review by parties interested in the construction project. If circumstances warrant it, the completed Sample Warranty can be provided to the user as a stand alone report, such as in a PDF document, which can be transmitted apart from the complete submittal package.

The reports can be converted into a read only format, which can be printed by the user but not altered electronically in step 118 using known software applications. An example which should not be considered limiting can include Adobe Acrobat PDF documents. For example, Crystal Reports® by Business Objects of San Jose, Calif., can be used to convert the reports to PDF documents, among others. The reports not able to be converted into PDF documents can be distilled into PDF documents by software applications, such as Adobe Distiller by Adobe of San Jose, Calif. For example, the Sample Warranty and/or Letter of Good Standing can be generated in Microsoft Word and then distilled into a PDF document.

The method can also include combining the reports and the pre-established documents to form a completed submittal package for transmitting to the user terminal at 124. The different PDF documents can be stitched together to form a single PDF document using known software applications, such as for example PDFLib GmbH of Munich, Germany. The completed submittal package can include the reports in PDF format including the Sample Warranty and Letter of Good Standing. The completed submittal package can also include the pre-established documents such as the MSDS sheets, TIS sheets, Drawings, etc. selected from the repository in the pre-selecting step at 110 and selected from the repository view at step 112. The completed submittal package can include a dynamically generated table of contents as well as dynamically generated footers with page numbers. The dynamically generated footer can also include information such as the contractor name and/or project name taken from the user information associated with the user during the authentication step 102 above.

The submittal package can be stored in a database at 126. The entire PDF document can be stored and associated with the contractor using the identifying information provided above. The system 10 can provide a link, such as a URL to the user terminal 14. The user can view the completed submittal package by clicking on the link provided. The system 10 can also provide a link, such as web page URL, or an HTML link, among others, to the package for downloading at 130, or the submittal package or portions of it can be sent to the user via email.

Manufacturers can use the system and method for automatically generating Submittal Packages describe herein to simplify the contractor's task of compiling and completing all of the necessary documentation need for a construction project. The invention can be used to strengthen the professional relationship between a manufacturer and contractors which can provide increased business for the building products manufacturer. The invention provides an effective system and method for collecting and integrating all of the necessary information into a Letter of Good Standing and Sample Warranty supplied by the manufacturer to the contractor. The invention also provides an effective system and method for sending the completed Letter of Good Standing and Sample Warranty from the manufacturer to the contractor.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

1. A method generating a submittal package comprising:
entering relational data using an Expert Logic Engine;
selecting pre-established documents corresponding to the relational data;
preparing reports from the relational data; and
combining the reports and documents to form a submittal package.

2. The method defined in claim 1 wherein the step of preparing reports includes preparing a Sample Warranty.

3. The method defined in claim 1 wherein the step of preparing reports includes preparing a Letter of Good Standing.

4. The method defined in claim 1 wherein the step of entering relational data further comprises:
determining data entry points;
performing validity checks on entered data using business/product rules; and
changing data entry points if the validity checks are not satisfied.

5. The method defined in claim 1 wherein the step of entering relational data further comprises entering roofing construction project information.

6. A method for generating a submittal package document comprising:
entering relational data using an Expert Logic Engine; and
preparing a Sample Warranty from the relational data.

7. The method defined in claim 6 wherein the step of entering relational data includes entering roofing construction project information.

8. The method defined in claim 6 further comprising:
transmitting the Sample Warranty to a user.

9. The method defined in claim 6 wherein the step of entering relational data further comprises:
determining data entry points;
performing validity checks on entered data using business/product rules; and
changing data entry points if the validity checks are not satisfied.

10. A method generating a submittal package document comprising:
entering relational data using an Expert Logic Engine; and
preparing a Letter of Good Standing from the relational data.

11. The method defined in claim 10 wherein the step of entering relational data includes entering roofing construction project information.

12. The method defined in claim 10 further comprising:
transmitting the Letter of Good Standing to a user.

13. The method defined in claim 10 wherein the step of entering relational data further comprises:
determining data entry points;
performing validity checks on entered data using business/product rules; and
changing data entry points if the validity checks are not satisfied.

14. A system for generating a submittal package comprising:
means for entering relational data using an Expert Logic Engine;
means for selecting pre-established documents corresponding to the relational data;
means for preparing reports from the relational data; and
means for combining the reports and documents to form a submittal package.

15. The system defined in claim 14 wherein the means for preparing reports includes means for preparing a Sample Warranty.

16. The system defined in claim 14 wherein the means for preparing reports includes means for preparing a Letter of Good Standing.

17. The system defined in claim 14 wherein the Expert Logic Engine comprises:
means for determining data entry points;
means for performing validity checks on entered data using business/product rules; and
means for changing data entry points if the validity checks are not satisfied.
